(19) United States
(12) Patent Application Publication
(10) Pub. No.: US 2025/0189433 A1
(43) Pub. Date: Jun. 12, 2025

(54) MULTIPASS ABSORPTION CELL

(71) Applicant: ALPES LASERS S.A., St-Blaise (CH)

(72) Inventors: Richard MAULINI, Marin-Epagnier (La Tène) (CH); Antoine MÜLLER, Neuchâtel (CH)

(73) Assignee: ALPES LASERS S.A., St-Blaise (CH)

(21) Appl. No.: 18/844,418

(22) PCT Filed: Mar. 7, 2023
(86) PCT No.: PCT/IB2023/052157

§ 371 Date: Sep. 6, 2024

Related U.S. Application Data
(60) Provisional application No. 63/317,917, filed on Mar. 8, 2022.

(51) Int. Cl. G01N 21/03; G01N 21/31

(52) U.S. Cl. CPC G01N 21/031; G01N 21/31; G01N 2201/0636

(57) ABSTRACT

Laser absorption spectroscopy using multipass absorption based on multi-plane light conversion is a very sensitive chemical sensing technique to determine the molecular composition and concentration of a sample, especially a gas sample. To achieve a long optical path length while keeping the detector small, many trace gas sensors rely on multipass absorption cells in which the beam is reflected multiple times. The novel approach of the present invention consists in using multi-plane light conversion (MPLC) phase plates as reflectors in such multipass absorption cells.

### FIELD OF THE INVENTION

This invention relates to multipass absorption cells based on multi-plane light conversion for optical spectroscopy and in particular to the design and fabrication of such cells.

### BACKGROUND OF THE INVENTION

Laser absorption spectroscopy is a very sensitive and selective chemical sensing technique in which molecular composition and concentration of a sample are determined by measuring its absorption spectrum with a laser source. Since the absorbance, A, of a sample is proportional to its concentration and to the optical path length, L, as described by the Beer-Lambert law, increasing L allows to detect lower concentrations of molecules. This is particularly relevant for gases which typically have a lower absorption per unit length, i.e. a lower attenuation coefficient, than solid state samples. To take advantage of a long optical path length while keeping a small form factor of the detector, many trace gas sensors rely on multipass absorption cells in which the beam is reflected multiple times to maximize the interaction length in a relatively small volume. The best known multipass cell designs are described by J. U. White, “Long Optical Paths of Large Aperture”, J. Opt. Soc. Am. 32 (5), 285 (1942) and by D. Harriott, H. Kogelnik, and R. Kompfner, “Off-Axis Paths in Spherical Mirror Interferometers”, Appl. Opt. 3 (4), 523 (1964). Both designs are based on spherical mirrors.

Various novel configurations have been introduced over the years to improve the optical path to volume ratio and performance. J. B. McManus et al. introduced in “Astigmatic mirror multipass absorption cells for long-path-length spectroscopy”, Appl. Opt. 34 (18), 3336 (1995) a variant of the Herriott design based on astigmatic mirrors and realized a cell with 100-m path length in a volume of 3 liters and a cell with 36-m path length in a volume of 0.3 liter.

More recently, Krzempek et al. showed in “CW DFB RT Diode Laser-Based Sensor for Trace-Gas Detection of Ethane Using a Novel Compact Multipass Gas Absorption Cell”, Applied Physics B 112, n° 4 (September 2013): 461-65 a dense-patterned multipass cell using two spherically aberrated mirrors. The optical path length in the cell was 57.6 m long in a 270 cm3, i.e. 0.27 liter, volume.

B. Tuzson et al. proposed and demonstrated in “Compact multipass optical cell for laser spectroscopy,” Opt. Lett. 38 (3), 257 (2013) a more compact design based on a single reflective toroidal surface which provides an optical path length of up to 7.1 m in a volume of merely 40 cm3 (0.04 liter).

Multipass cells are challenging to manufacture. In particular, scattering on the mirror surfaces or any stray light may hinder the practical use of this type of cells for absorption spectroscopy by causing interference fringes as described by B. Tuzson et al. above. The existing solutions are based on large mirrors and require significant volume and adjustment, as described in Krzempek et al. above and references therein.

The present invention uses a novel approach to realize compact, long-optical-path, multipass cell based on multi-plane light conversion by using multi-plane light conversion (MPLC).

Multi-plane light conversion (MPLC) is a low-loss beam shaping process that allows to perform any desired unitary transform of an optical mode as described by J. F. Morizur et al. in “Programmable Unitary Spatial Mode Manipulation”, Journal of the Optical Society of America A 27, no. 11 (1 Nov. 2010): 2524.

MPLC is ideal for multiple-beam systems, as the beams can be shaped simultaneously. MPLC can be implemented in both transmissive and reflective configurations. A particularly attractive implementation of MPLC for multipass absorption cells relies on multiple reflections between a reflective phase plate and a mirror, as disclosed in a number of patents and patent applications, e.g. U.S. Pat. No. 10,382,133 B2, WO 2018134534 A1, WO 2016037850 A1, and in a paper by Guillaume Labroille et al. entitled “Characterization and Applications of Spatial Mode Multiplexers Based on Multi-Plane Light Conversion”, Optical Fiber Technology 35 (February 2017): 93-99. This paper discloses that MPLC can perform an arbitrary unitary transformation. This is exemplified by demonstrating the injection of the light from 10 separate single mode fibres into orthogonal modes of a multi-mode fibre as shown in FIG. 2 of this paper. The MPLC is realised with the light injected from a linear array of single mode fibres onto a phase plate and bouncing 14 times between the phase plate and the mirror before to exit to the multi-mode fibre. The phase plate shape defines the light transformation and is optimised to realise the mode transformation from 10 fundamental modes of a single mode fibre to one of the modes of a multi-modes fibre.

These approaches result in a small volume which is advantageous for many applications. Further, reflective MPLC systems avoid the dispersion and absorption resulting from propagating through refractive optics. The present invention modifies this technology to realize long-optical-path gas cells in a small volume.

U.S. Pat. No. 10,382,133 B2 describes the MPLC as an optical phase-shifting component used for shifting the phase and modifying the intensity of the light beam injected into a fiber. The component is inserted somewhere in the fiber. It uses two mirrors and multiple beam paths between the mirrors. An optical phase-shifting structure, e.g. a reflective phase mask with a structured surface, eventually a mirror, is effective at each reflection of the beam and gradually splits the beam into faster and slower propagation modes. The faster modes are subjected to one or more reflections more than the slower modes and are thereby decelerated. The fast and slow modes are combined again and are then transmitted in a multimode fiber in which the modes have different propagation speeds. However, this design must be modified to be of use in a gas cell.

### SUMMARY OF THE INVENTION

An MPLC system allows to modify the optical modes of 50 single mode fibres in a bundle and inject them in 50 higher order modes of a multi-mode fibre with an extremely small cross talk and low losses. Given that the modes are characterised by their direction, shape, phase front and location and given that the MPLC can be designed to transform arbitrarily any mode into any other, one can repurpose the MPLC with the following properties. Instead of placing a number of single mode fibres at the input, one places two fibres and a mirror normal to the fibre optical axis. At the exit, one places a mirror normal to the exit optical axis. Instead of modifying the mode shape, one changes the mode location and direction on the exit reflective plane in such a way that for each exiting beam there is an accepted reflected beam that will travel in the opposite direction towards the mirror placed next to the input fibre. At this point the same design is applied, the exiting beam on the input side aiming at the mirror will be reflected and injected into an accepted mode of the MPLC, will travel back to the original exit side. This process goes on until the last travel through the MPLC is performed and at this point the MPLC is designed to inject the light into the exiting fibre.

Considering a 10-bounce MPLC of centimeter size and a 50-fold reflection path, one gets a multipass cell of an effective length of 5 meters to be compared with present commercial cells such as the cells described by J. B. McManus et al. and B. Tuzson et al., cited above. Furthermore, whereas existing commercial cells are machined, a MPLC can be fabricated using planar semiconductor fabrication processes having the advantage of parallelization, i.e. the fabrication of numerous units simultaneously on a single wafer. Thus, the volume price of the described novel embodiment can be significantly lower that a machined version.

### BRIEF DESCRIPTION OF THE DRAWINGS

In the attached drawings show:

FIG. 1 a schematic representation of a multipass gas cell based on MPLC

FIG. 2a a schematic top view of a free-space-coupled multipass gas cell based on MPLC

FIG. 2b an isometric view of the cell of FIG. 2a

FIG. 3a a schematic top view of a fiber-coupled multipass gas cell based on MPLC

FIG. 3b an isometric view of the cell of FIG. 3a

FIG. 4a example of a three-row square reflection pattern on the cell mirror

FIG. 4b an example of a similar three-row hexagonal pattern

FIG. 5a a schematic top view of a fiber-coupled multipass gas cell based on MPLC

FIG. 5b an isometric view of the cell of FIG. 5a

### DETAILED DESCRIPTION OF THE INVENTION

The following describes particular embodiments of the invention. It is understood that the embodiments described here are only examples and that one skilled in the art may utilize other embodiments without departing from the scope of the present invention as defined in the claims.

Based on the above Labroille paper, one learns that using the MPLC in reverse, i.e. injecting into the output, provides the inverse unitary transformation thus injecting the many modes from the multi-mode fibre and converting it back to 10 separate single modes. A possible embodiment of a spectroscopic cell can be provided by placing a second MPLC in front of the first one in such a way as to reduce the length of the multi-mode fibre to zero. The output of this second MPLC is again 10 single mode fibres and one can connect the first to the second, at the input the second to the third, at the output the third to the forth and so on. The light in this configuration will travel 10 times through the device performing 14 reflections in each MPLC.

This embodiment is not optimal as it uses two MPLCs and requires to inject into the fibres and back into the MPLS at each full travel through the system. The first improvement would be to use a single phase plate using 28 bounces by employing the same phase plate design on a twice as large plate and reproducing the original pattern on the first half and its mirrored version on the second half. An additional improvement will then be to change the orientation of the exiting modes so that they face each other by pairs and are reinjected into the MPLC by a flat mirror placed at the location of the fibre array where at the input only two fibres are kept, the first and the last, and at the opposite exit a flat mirror covers all the fibre locations.

In the above embodiment, one converts the injected single mode into the modes of a multimodes fibre and back to single mode. This is a useless transformation and possibly sub optimal. In order to realise a multipass cell that is pertinent to spectroscopy application, one wants to optimise the system differently.

Three features or attributes seem to lead to an optimised embodiment.

First, the phase plate and the mirror shall provide the highest reflectivity at the wavelength of operation, as the light will bounce between the phase plate and the mirror many times. The higher the reflectivity, the lower the accumulation of reflection losses.

Second, and independent from the first, only the injection mode coming from the laser and the exit mode are the boundary conditions of the optimisation. The injection mode may vary slightly from the fabrication variabilities that impact on the far-field energy distribution and shape. The exit mode shall be easy to be collected by a detector, practically, it shall cover the detector and be as small as the detector can be manufactured. This condition maximizes signal to noise ratio and minimizes non-linearity.

Third, the intermediate unitary transformations leading to the intermediate modes have no additional constraints on shape than accepting the laser mode and exiting to the detector. However, it is necessary for the application to realise the function that it can still provide the function if the input wavelength changes, typically by one wave-number or if the temperature varies or the physical alignment of the laser against the system.

To optimise the second and third attributes, one can define a figure of merit that can be used as an optimisation function for an automated design search such as genetic algorithm or similar techniques. The goal being to be able to scan a small wavelength region in order to observe the variation of the absorption of the gases present between the mirrors of the MPLC and to avoid that these changes in attenuation are hidden by unrelated fluctuations. Such fluctuations may occur as the total transmission of the system changes because of the wavelength change or because there is cross talk between modes having bounced a different number of times. Further, acoustic vibrations may create interferences or loss of signal. To evaluate the signal-to-noise ration, one can simulate the output signal with a given modality for the alignment of the laser, the mirrors towards one another, the wavelength, and the temperature. Then one can average the output power and its variance. The modalities for the alignment of the laser and the mirrors must be chosen to reflect the range of errors introduced by acoustic pressure. Further, the temperature range modality must reflect the precision of the range in which a temperature controller of adequate cost will be able to maintain the MPLC and the flowing gas, the wavelength modality must explore the full wavelength range necessary for completing the spectroscopy. A sufficiently large number of realisations of the various modalities must be explored to make sure there is no aliasing due to undersampling of the modalities. A criterion is that doubling the number of samples shall change the signal to noise ratio less than the difference of signal to noise ratio of another configuration for the same number of modalities.

This optimisation maximises performances but this may be at the cost of very difficult alignments, temperature stability or acoustical quietness. In order to optimise for the fabrication parameters, the mechanical precision achievable for a given cost is calculated as well as the temperature stability. The pool of solutions obtained from the first step reaching a sufficiently high signal to noise ratio is reevaluated, this time sampling on the modalities of fabrication alignment using the portion reaching acceptable performances as the figure of merit for the final selection of candidate designs.

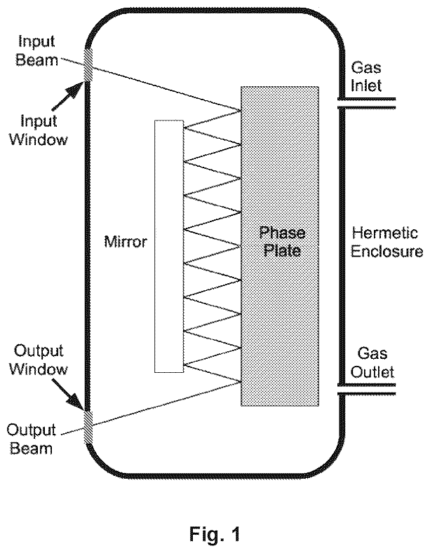

The overall architecture of a multipass gas cell based on MPLC according to the present invention is shown in FIG. 1. The cell is composed of a reflective MPLC phase plate, a mirror and a hermetic enclosure equipped with gas inlet and outlet and optical windows. The purpose of the enclosure is to keep the sample gas under characterization separate from the ambient atmosphere and to control the gas pressure inside the cell. The hermetic enclosure must be equipped with at least one optical window to let the input beam enter the cell and the let the output beam exit the cell.

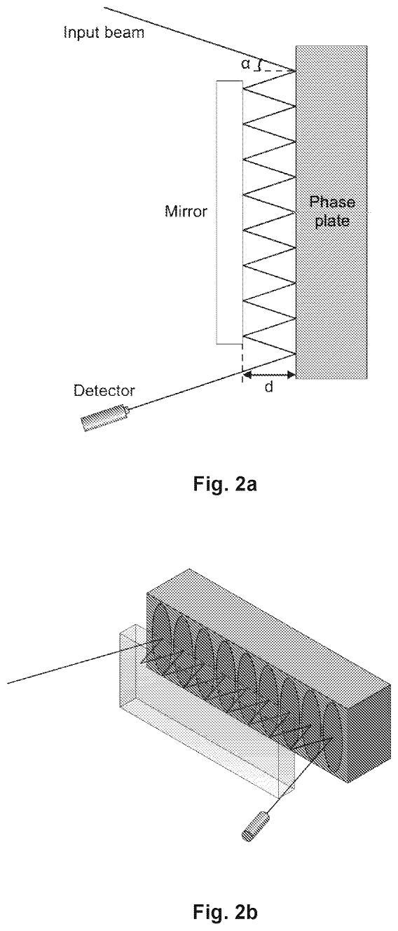

A first embodiment of a multipass gas cell according to the present invention is a single beam cell as depicted in FIGS. 2a and 2b. The hermetic enclosure is not shown. In this embodiment, the input laser beam propagates in free space. The beam undergoes multiple reflections between the phase plate and the mirror which creates a long optical path length in a small volume. The phase plate is designed to compensate the intrinsic divergence of the beam due to diffraction to keep the diameter constant reflection after reflection. The phase plate can be designed either to collimate the output beam, if it needs to be propagated over a long distance, or to focus the output beam at a short distance from the cell where the detector is located.

The optical path length in the cell, L, is larger or equal to

$$L \geq 2 ( N + 1 ) \frac{d}{cos α}$$

where d is the distance between the phase plate and the mirror, N is the number of reflections on the mirror, and a is the angle between the beam and the normal to the phase plate. In order to maximize the optical path length to volume ratio of the cell, the distance between subsequent reflections on the mirror is typically chosen to be much smaller than d and, hence the optical path length can be approximated by

$$L ≅ 2 ( N + 1 ) d$$

For instance, in a cell with a distance d=10 cm between the mirror and the phase plate and N=20 reflections on the mirror, the optical path length is approximately equal to L=4.2 m.

The phase plate for this first embodiment is designed to be compatible with a laser beam propagating in free space. To achieve this, a reflective phase plate is used. The desired spatial phase profile ø(x,y) is realized by etching a corresponding height profile z(x,y) in a substrate, e.g. a glass plate. A high-reflectivity coating, typically a metallic film, is then deposited on the surface to maximize its reflectance.

To reproduce the beam diameter and beam divergence of the input beam at the output of the cell, in this first embodiment, the N phase profiles corresponding to the N reflections on the phase plate are N identical concave spherical or parabolic surfaces. This arrangement produces a periodic sequence of free-space propagation over a distance 2d followed by a focusing mirror of focal length f. For such a periodic system to support a stable ray trajectory which repeats after N periods, the focal length must be chosen to satisfy the condition

$$f = \frac{d}{2 {sin}^{2} \frac{π}{N}}$$

In the case of a spherical mirror, the focal length A of the mirror is related to its radius of curvature R by R=2f. Therefore, the radius of curvature should fulfill the condition

$$R = \frac{d}{{sin}^{2} \frac{π}{N}}$$

A phase plate constituted of N spherical mirrors fulfilling this condition reproduces the diameter and divergence of the input beam at the output of the cell.

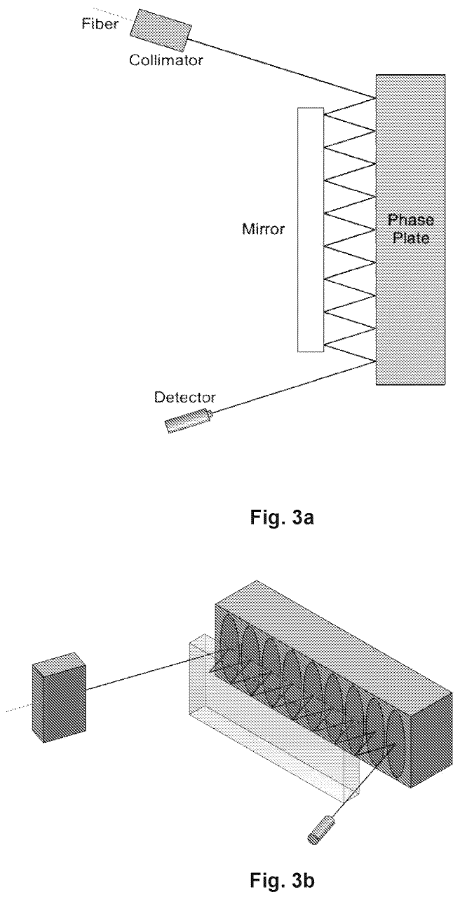

In a second embodiment of the invention, a single beam is delivered to the multipass cell by an optical fiber and collimated by a collimator lens attached to the extremity of the fiber patch cable as shown schematically in FIGS. 3a and 3b.

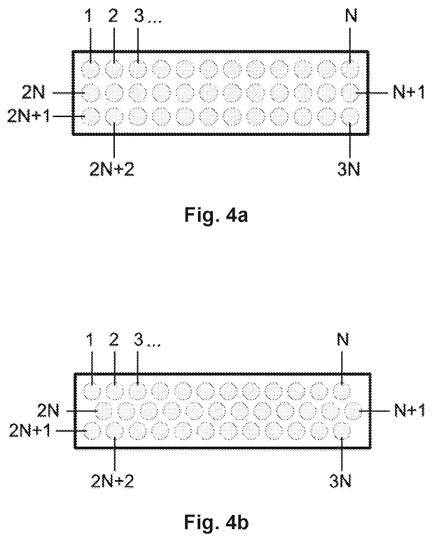

The great design and fabrication flexibility of MPLC phase plates allows to generate dense, multi-row reflection patterns on the mirror. By stacking vertically M rows of multiple reflections, as illustrated in FIGS. 4a and 4b for M=3, the optical path is increased proportionally to the number of rows as

$$L ≅ 2 M ( N + 1 ) d$$

For instance, in a cell with a distance d=10 cm between the mirror and the phase plate, N=20 reflections on the mirror per row, and M=3 rows, the optical path length is approximately equal to L=12.6 m.

The design and fabrication flexibility of MPLC phase plates allows to generate multi-row reflection patterns arranged in a hexagonal lattice (also called triangular lattice) on the mirror. This is the densest packing of circles in two dimensions.

When an application requires to detect multiple gases with non-overlapping absorption spectra, the tuning range of a single laser is not sufficient and several lasers need to be integrated in a single sensor cell.

Multipass cells require a very precise control of the position and of the angle of incidence of the input beam to achieve the specified performance. Therefore, it is challenging to couple multiple lasers beams into a single multipass cell. The beams need to be made parallel and collinear using external beam combining optics before entering the cell. This is typically achieved using polarization beam combining and/or spectral beam combining with dichroic mirrors or diffraction gratings.

Multi-plane light conversion has been shown to be a powerful technology for beam combining, see e.g. the two references G. Labroille et al. above. The output beam of multiple single-mode optical fibers can be efficiently multiplexed into a single multi-mode fiber by converting them into orthogonal spatial modes.

The phase plate for this second embodiment will be similar to the one defined in connection with the first embodiment.

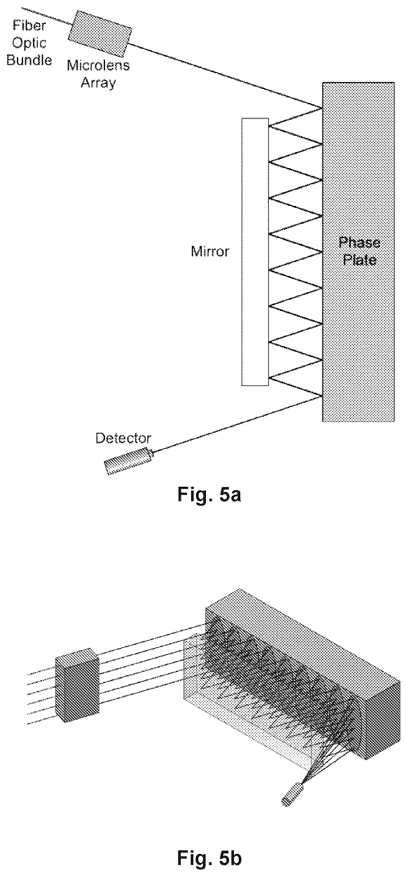

In another embodiment of the invention, multiple non-collinear beams propagate into an MPLC multipass cell together and are combined onto a detector at the output of the cell. In this multi-beam cell configuration, illustrated in FIGS. 5a and 5b, the MPLC phase plates and mirror fulfill two different functionalities: a) create a long optical path length in a small volume and b) combine the multiple input beams. Contrary to traditional multipass cells, it is not necessary to combine the beams before entering the cell. The beams are delivered to the cell by a fiber bundle and collimated by a microlens array, as shown in FIG. 5a.

In order to accept M parallel, non-collinear beams at the input and to direct them to a single detector at the output, the MPLC phase plate of this embodiment can, for example, be structured as follows. Each individual phase profile, except the last one, consist of M stacked spherical or parabolic surfaces with radii of curvature determined as for the single beam cell. The last phase profile consists of M stacked flat surfaces which are angled in such a way that the M individual beams are steered to intersect at the single point where the detector is placed. This is just one example, but there are other combinations of phase profiles which can be used to realize such a cell.

In the case of gas sensors utilizing semiconductor lasers, e.g. near infrared diode lasers or mid-infrared quantum cascade lasers, it is possible to reduce the size of not only the multipass cell but of the entire sensor, which comprises the light source, the gas absorption cell, and the photodetector, by attaching or integrating a laser chip and its collimation optics at the entrance of the cell instead of an optical fiber and its collimation optics.

The same is also true for multi-gas sensors which require multiple lasers. Instead of a fiber optic bundle delivering the light from several laser sources, a semiconductor laser array chip containing multiple emitters with different wavelengths can be mounted or integrated at the entrance of the cell and collimated by a microlens array.

To summarize, a novel multipass cell architecture based on a reflective MPLC phase plate and a mirror is presented. This architecture is compatible with free-space coupling and fiber-coupling of laser sources. It allows to create long optical path lengths in a small volume by generating very dense reflection patterns, including the hexagonal lattice pattern which is the densest arrangement of circles.

The disclosed MPLC multipass cell architecture offers the unique possibility of coupling multiple spatially separated laser beams without prior beam combining. The beam combining is achieved by the cell itself and the beams are sent to a single detector at the exit. This multi-beam configuration can be realized either with a fiber bundle to deliver the beam to the cell and a microlens array for collimation or, in the case of semiconductor lasers, with a laser array chip mounted at the entrance of the cell and a microlens array for collimation.

MPLC can be fabricated using planar fabrication processes having the advantage of parallelization, i.e. the fabrication of numerous units simultaneously on a single wafer. Therefore, the volume price for the fabrication of MPLC-based multipass cells can be significantly lower that current machined cells.

1. A multipass gas absorption cell comprising at least two reflective means, said reflective means arranged to increase the total optical path length of a laser beam within an enclosure or chamber containing the gas to be analysed, wherein at least one of said reflective means being a reflective multi-plane light conversion (MPLC) phase plate.

2. The gas absorption cell of claim 1, wherein to analyze the gas at multiple wavelengths, several spatially separate laser beams of different wavelengths entering the chamber are converted into orthogonal spatial modes which are reflected by the reflective MPLC phase plate within said chamber and measured by a single detector.

3. The gas absorption cell of claim 1, wherein the chamber contains at least one optical mirror and inlet and outlet for the gas and at least one optical window for a laser beam.

4. The gas absorption cell according to claim 1, wherein the MPLC phase plate exhibits a spatial phase profile compatible with a laser propagating in free space, said spatial phase profile being realized by producing a corresponding height profile of the reflective surface of said MPLC phase plate.

5. The gas absorption cell according to claim 1, wherein the MPLC phase plate exhibits a spatial phase profile compatible with a laser propagating in an optical fiber, said spatial phase profile being realized by producing a corresponding height profile of the reflective surface of said MPLC phase plate.

6. The gas absorption cell according to claim 4, wherein the spatial phase profile is produced by etching a desired height profile into the surface of the MPLC phase plate, preferably by making several MPLC phase plates on a single glass wafer using planar fabrication techniques and by depositing a metallic film onto said surface to increase its reflectivity.

7. The gas absorption cell according to claim 1, wherein N phase profiles corresponding to N reflections on the MPLC phase plate are provided by N identical concave spherical or parabolic mirrors on the surface.

8. The gas absorption cell according to claim 7, wherein the N mirrors are arranged in stacked rows of multiple mirrors resulting in an increased optical path length.

9. The gas absorption cell according to claim 3, wherein a single beam is delivered to said cell through an optical fiber, said fiber having a collimator at its end facing said cell.

10. The gas absorption cell according to claim 1, the multi-plane light conversion (MPLC) phase plate being a glass structure made by planar manufacturing processes preferably by making several phase plates on a single wafer.
